(19) United States
(12) Patent Application Publication
(10) Pub. No.: US 2019/0191389 A1
(43) Pub. Date: Jun. 20, 2019

(54) Method of Handling Power Control and Related Communication Device

(71) Applicant: HTC Corporation, Taoyuan City (TW)

(72) Inventors: Yi-How Fu, Taoyuan City (TW); Paul James BROWN, Taoyuan City (TW); Ke-Ping Chang, Taoyuan City (TW)

(21) Appl. No.: 16/218,449

(22) Filed: Dec. 12, 2018

Related U.S. Application Data
(60) Provisional application No. 62/599,778, filed on Dec. 17, 2017.

(51) Int. Cl. H04W 52/24; H04W 52/26; H04W 52/36

(52) U.S. Cl. CPC H04W 52/248; H04W 52/265; H04W 52/367; H04W 52/246; H04W 52/241

(57) ABSTRACT

A communication device receives a first indication indicating the communication device to adjust a data transmission power or a control transmission power from a network; keeps the data transmission power and keeps the control transmission power in response to the first indication, when a total transmission power of the data transmission power and the control transmission power is greater than or equal to a maximum transmission power; and transmits a data channel with the data transmission power and transmits a control channel with the control transmission power.

### CROSS REFERENCE TO RELATED APPLICATIONS

This application claims the benefit of U.S. Provisional Application No. 62/599,778 filed on Dec. 17, 2017, which is incorporated herein by reference.

### BACKGROUND OF THE INVENTION

### 1. Field of the Invention

The present invention relates to a communication device and a method used in a wireless communication system, and more particularly, to a communication device and a method of handling a power control.

### 2. Description of the Prior Art

When a channel quality (CQ) degrades, a user equipment (UE) increases a transmission power to compensate the degradation of the CQ. When the CQ improves, the UE decrease the transmission power to reduce interference to other UE(s). If the CQ keeps degrading, the UE keeps increasing the transmission power and the transmission power may reach (or exceed) a maximum transmission power of the UE. However, after the transmission power reaches the maximum transmission power, the transmission power causes significant interference to the other UE(s). Thus, how to handle a power control is an important problem to be solved.

### SUMMARY OF THE INVENTION

The present invention therefore provides a method and related communication device for handling a power control to solve the abovementioned problem.

A communication device for handling a power control, comprises at least one storage device and at least one processing circuit coupled to the at least one storage device. The at least one storage device stores, and the at least one processing circuit is configured to execute instructions of: receiving a first indication indicating the communication device to adjust a data transmission power or a control transmission power from a network; keeping the data transmission power and keeping the control transmission power in response to the first indication, when a total transmission power of the data transmission power and the control transmission power is greater than or equal to a maximum transmission power; and transmitting a data channel with the data transmission power and transmitting a control channel with the control transmission power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a schematic diagram of handling a power control according to an example of the present invention.

FIG. 5 is a flowchart of a process according to an example of the present invention.

FIG. 6 is a schematic diagram of handling a power control according to an example of the present invention.

FIG. 7 is a flowchart of a process according to an example of the present invention.

FIG. 8 is a schematic diagram of handling a power control according to an example of the present invention.

### DETAILED DESCRIPTION

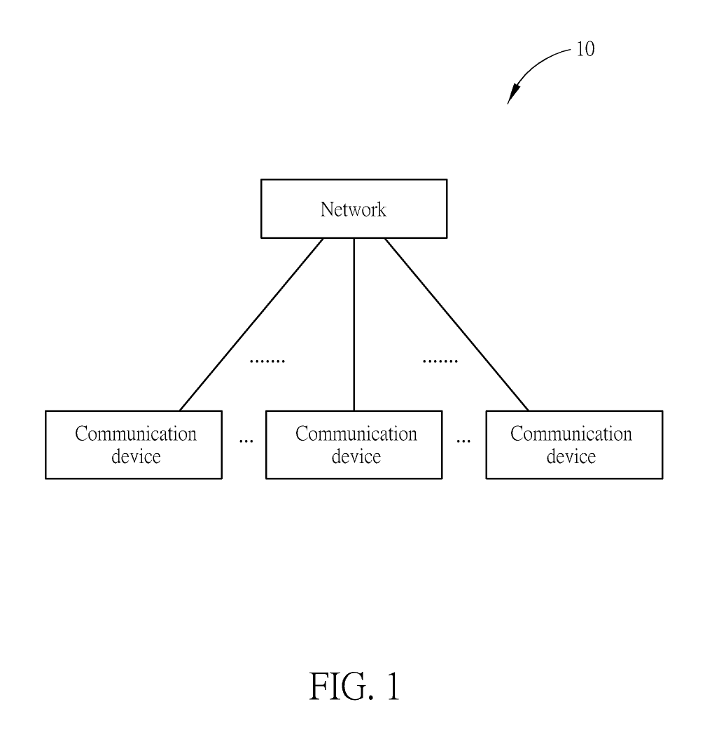

In FIG. 1, the wireless communication system 10 is briefly composed of a network and a plurality of communication devices. The network and the communication device may (e.g., simultaneously) communicate with each other. The network in FIG. 1 may be a Code Division Multiple Access (CDMA) network, which is interference-limited, e.g., the number of the plurality of communication devices in the wireless communication system is limited by interference.

A communication device may be a user equipment (UE), a mobile phone, a laptop, a tablet computer, an electronic book, a portable computer system, a vehicle, or an aircraft. In addition, the network and the communication device can be seen as a transmitter or a receiver according to direction (i.e., transmission direction), e.g., for a uplink (UL), the communication device is the transmitter and the network is the receiver, and for a downlink (DL), the network is the transmitter and the communication device is the receiver.

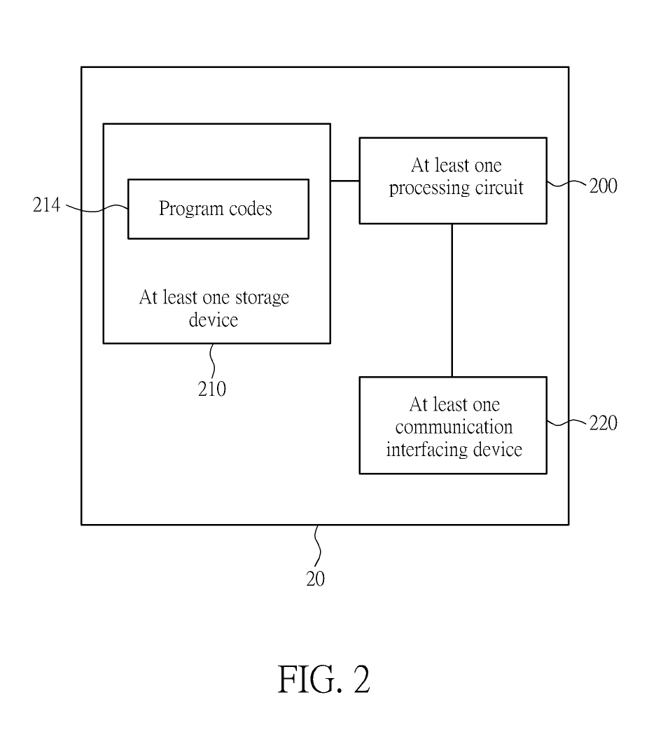

FIG. 2 is a schematic diagram of a communication device 20 according to an example of the present invention. The communication device 20 may be the communication device 100, the BS(s) 102 and/or 104 shown in FIG. 1, but is not limited herein. The communication device 20 may include at least one processing circuit 200 such as a microprocessor or Application Specific Integrated Circuit (ASIC), at least one storage device 210 and at least one communication interfacing device 220. The at least one storage device 210 may be any data storage device that may store program codes 214, accessed and executed by the at least one processing circuit 200. Examples of the at least one storage device 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage device, non-transitory computer-readable medium (e.g., tangible media), etc. The at least one communication interfacing device 220 is preferably at least one transceiver and is used to transmit and receive signals (e.g., data, messages and/or packets) according to processing results of the at least one processing circuit 200.

In the following examples, a UE is used for representing the communication device 100 in FIG. 1, to simplify the illustration of the embodiments.

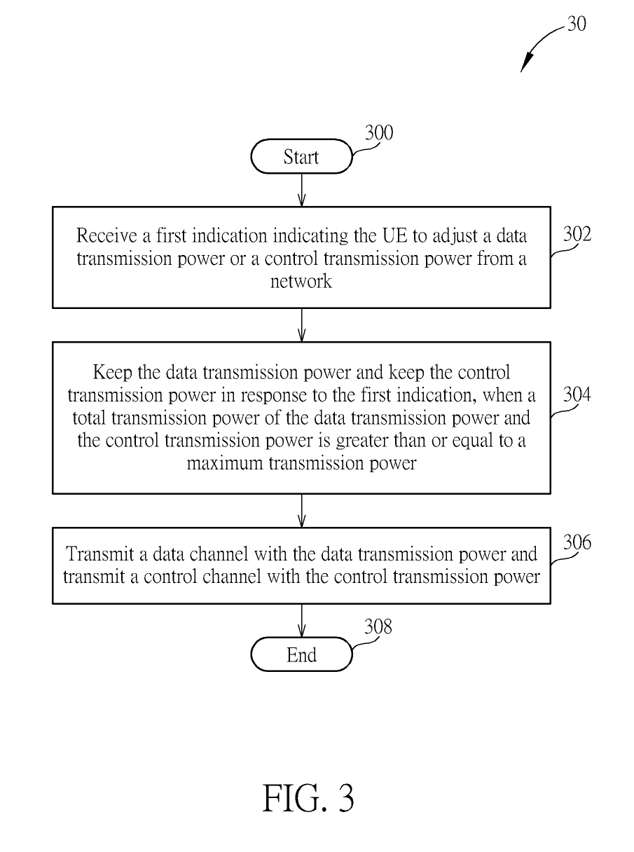

A process 30 in FIG. 3 according to an example of the present invention may be utilized in a UE. The process 30 includes the following steps:

Step 300: Start.

Step 302: Receive a first indication indicating the UE to adjust (e.g., increase or decrease) a data transmission power or a control transmission power from a network.

Step 304: Keep the data transmission power and keep the control transmission power in response to the first indication, when a total transmission power (e.g., after adjusting the control transmission power and a gain factor) of the data transmission power and the control transmission power is greater than or equal to a maximum transmission power (e.g., maximum allowed power of the UE).

Step 306: Transmit a data channel with the data transmission power and transmit a control channel with the control transmission power.

Step 308: End.

According to process 30, the UE keeps (i.e., does not adjust) the data transmission power rather than preferentially (e.g., firstly) adjusts the data transmission power when the total transmission power is greater than or equal to the maximum transmission power, even if the UE receives the first indication indicating the UE to adjust the data transmission power or the control transmission power from the network.

In one example, the UE adjusts the data transmission power to an adjusted transmission power and adjusts the control transmission power to an adjusted control power with a same proportion (e.g., both are increased or decreased with 10% of the maximum transmission power) in response to the first indication, when the total transmission power of the data transmission power and the control transmission power is smaller than the maximum transmission power. Then, the UE transmits the data channel with the adjusted data transmission power, and transmits the control channel with the adjusted control transmission power.

In one example, the UE stops keeping the data transmission power and stops keeping the control transmission power, when the UE receives a second indication indicating the UE to decrease the total transmission power (e.g., to be smaller than the maximum transmission power) from the network. That is, the UE keeps the data transmission power and keeps the control transmission power until receiving the second indication. Accordingly, the UE decreases the total transmission power in response to the second indication.

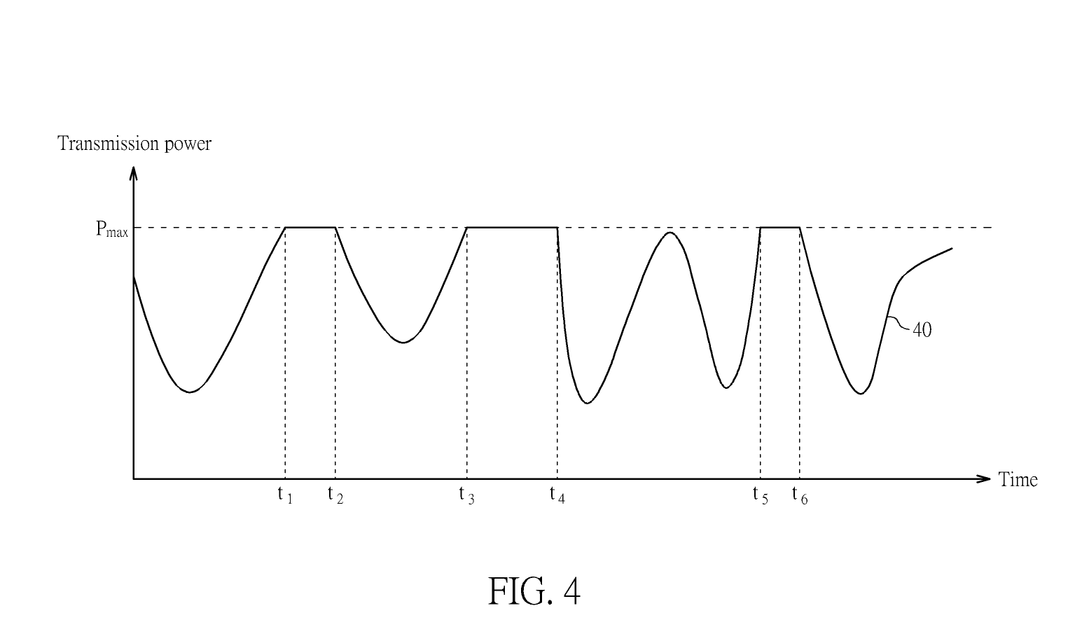

FIG. 4 is a schematic diagram of handling a power control according to an example of the present invention. In FIG. 4, X-axis represents time, and Y-axis represents transmission power. A line 40 illustrates total transmission powers of a UE at time instants. Total transmission powers at time instants t1-t6 are discussed. At each of time instants t1, t3, and t5, a total transmission power of a data transmission power and a control transmission power is equal to a maximum transmission power Pₘₐₓ of the UE. Accordingly, the UE keeps the data transmission power and keeps the control transmission power, and transmits a data channel with the data transmission power and transmits a control channel with the control transmission power to a network. In other words, the total transmission power is kept at a same value, i.e., the maximum transmission power Pₘₐₓ. At each of time instants t2, t4, and t6, the UE receives an indication indicating the UE to decrease the total transmission powers to be smaller than the maximum transmission power Pₘₐₓ from the network. Accordingly, the UE decreases the total transmission power to be smaller than the maximum transmission power Pₘₐₓ.

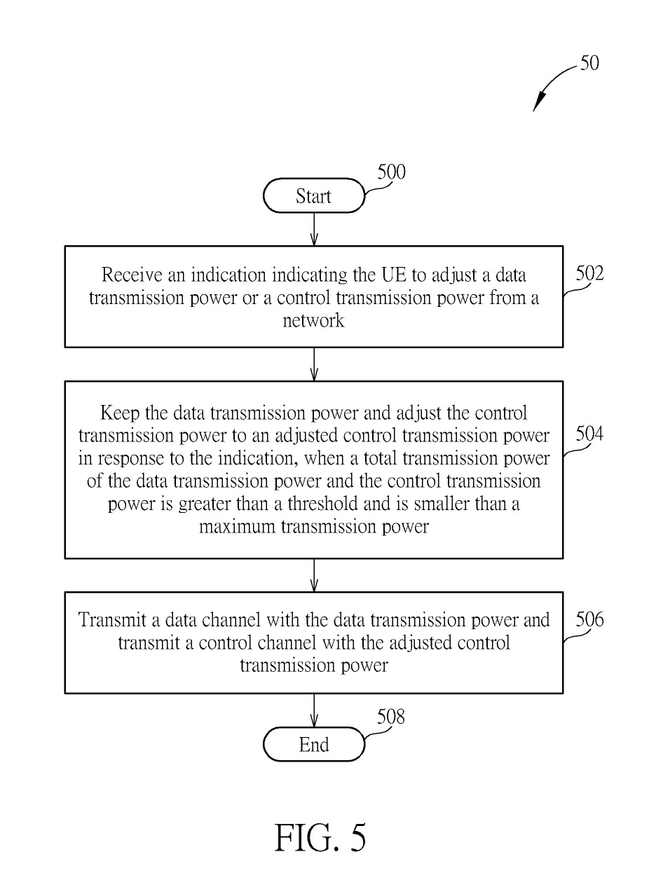

A process 50 in FIG. 5 according to an example of the present invention may be utilized in a UE. The process 50 includes the following steps:

Step 500: Start.

Step 502: Receive an indication indicating the UE to adjust (e.g., increase or decrease) a data transmission power or a control transmission power from a network.

Step 504: Keep the data transmission power and adjust the control transmission power to an adjusted control transmission power in response to the indication, when a total transmission power (e.g., after adjusting the control transmission power and a gain factor) of the data transmission power and the control transmission power is greater than (or equal to) a threshold and is smaller than a maximum transmission power (e.g., maximum allowed power of the UE).

Step 506: Transmit a data channel with the data transmission power and transmit a control channel with the adjusted control transmission power.

Step 508: End.

According to process 50, the UE keeps (i.e., does not adjust) the data transmission power rather than preferentially (e.g., firstly) adjusts the data transmission power and adjusts the control transmission power when the total transmission power is greater than the threshold and is smaller than the maximum transmission power, even if the UE receives the indication indicating the UE to adjust the data transmission power or the control transmission power from the network. That is, the power reserved on the data channel is used for the control channel. Thus, the UE reserves more power for transmitting the control channel, when the total transmission power is greater than the threshold and is smaller than the maximum transmission power.

In one example, the threshold is x % of the maximum transmission power, wherein x is an positive integer smaller than 100. For example, the threshold is 90% of the maximum transmission power, when x is 90. For example, the threshold is 80% of the maximum transmission power, when x is 80.

In one example, the UE keeps the data transmission power and keeps the control transmission power in response to the indication when the total transmission power of the data transmission power and the control transmission power is greater than or equal to the maximum transmission power, even if the UE receives the indication indicating the UE to adjust the data transmission power or the control transmission power from the network. Then, the UE transmits the data channel with the data transmission power and transmits the control channel with the control transmission power.

In one example, the UE stops keeping the data transmission power, when the total transmission power is smaller than the threshold. That is, the UE keeps the data transmission power until the total transmission power drops back to the threshold. In one example, the UE stops keeping the data transmission power and stops keeping the control transmission power, when the UE receives a second indication indicating the UE to decrease the total transmission power (e.g., to be smaller than the maximum transmission power) from the network. Accordingly, the UE decreases the total transmission power in response to the second indication.

In one example, the UE adjusting the control transmission power to the adjusted control transmission power in response to the indication includes: the UE decreases the control transmission power to the adjusted control transmission power, when the indication indicates the UE to decrease the control transmission power due to a channel quality (CQ) improvement (i.e., the CQ is getting better). In one example, the UE adjusting the control transmission power to the adjusted control transmission power in response to the indication includes: the UE increases the control transmission power to the adjusted control transmission power, when the indication indicates the UE to increase the control transmission power due to a CQ degradation (i.e., the CQ is getting worse).

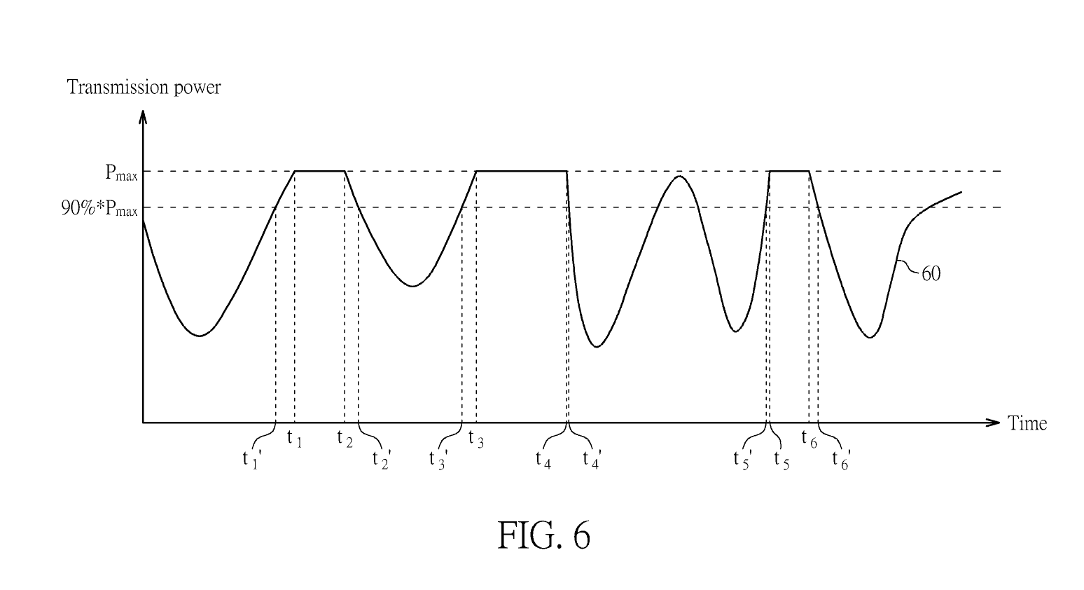

FIG. 6 is a schematic diagram of handling a power control according to an example of the present invention. In FIG. 6, X-axis represents time, and Y-axis represents transmission power. A line 60 illustrates total transmission powers of a UE at time instants. Transmission powers at time instants t1-t6 and t1′-t6′ are discussed. At each of time instants t1′, t3′, and t5′, a total transmission power of a data transmission power and a control transmission power is equal to 90% of a maximum transmission power Pₘₐₓ of the UE. Accordingly, the UE keeps the data transmission power and transmits a data channel with the data transmission power until the total transmission power drops back to 90% of the maximum transmission power. At each of time instants t1, t3, and t5, the total transmission power is equal to the maximum transmission power Pₘₐₓ. Accordingly, the UE keeps the data transmission power and keeps the control transmission power, and transmits the data channel with the data transmission power and transmits a control channel with the control transmission power. In other words, the total transmission power is kept at a same value, i.e., the maximum transmission power Pₘₐₓ. At each of time instants t2, t4, and t6, the UE receives an indication indicating the UE to decrease the total transmission power to be smaller than the maximum transmission power Pₘₐₓ from a network. Accordingly, the UE decreases the total transmission power to be smaller than the maximum transmission power Pₘₐₓ. The UE transmits the data channel with the kept data transmission power at time instants t1, t1′, t3, t3′, t5 and t5′, and still adjusts the control transmission powers at time instants t1′, t3′ and t5′. At each of time instants t2′, t4′, and t6′, the UE receives another indication indicating the UE to decrease the total transmission power to be smaller than 90% of the maximum transmission power Pₘₐₓ from the network. Accordingly, the UE decreases the total transmission power to be smaller than 90% of the maximum transmission power Pₘₐₓ. Afterward, the UE adjusts the data transmission power and adjusts the control transmission power.

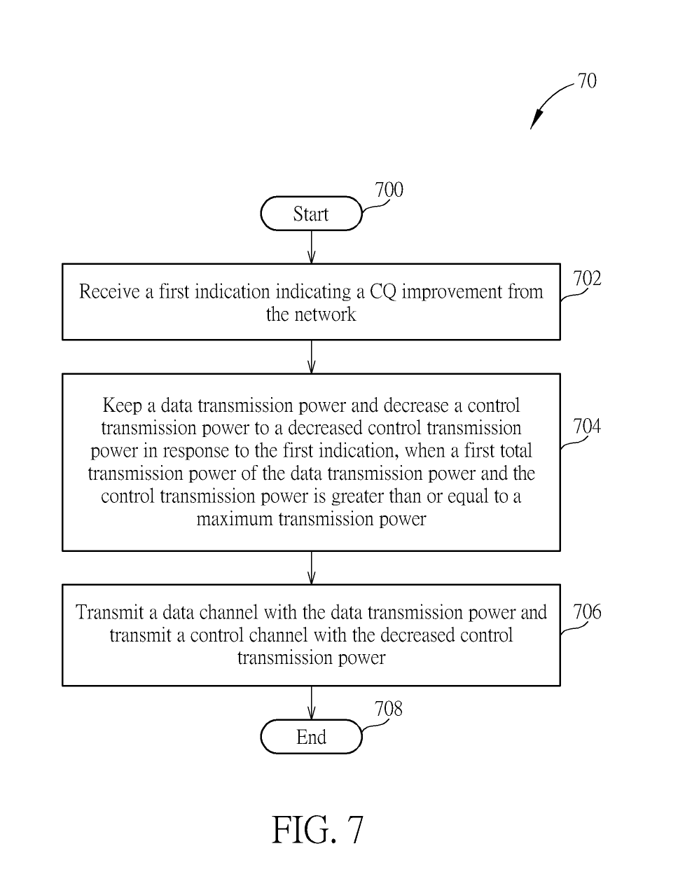

A process 70 in FIG. 7 according to an example of the present invention may be utilized in a UE. The process 70 includes the following steps:

Step 700: Start.

Step 702: Receive a first indication indicating a channel quality (CQ) improvement (e.g., the CQ is getting better) from the network.

Step 704: Keep a data transmission power and decrease a control transmission power to a decreased control transmission power in response to the first indication, when a first total transmission power of the data transmission power and the control transmission power is greater than or equal to a maximum transmission power.

Step 706: Transmit a data channel with the data transmission power and transmit a control channel with the decreased control transmission power.

Step 708: End.

According to process 70, the UE keeps (i.e., does not adjust) the data transmission power rather than preferentially (e.g., firstly) adjusts the data transmission power when the total transmission power is greater than or equal to the maximum transmission power, even if the UE receives the first indication indicating the CQ improvement from the network.

In one example, the UE receives a second indication indicating a CQ degradation (e.g., the CQ is getting worse) from the network, after keeping the data transmission power and decreasing the control transmission power to the decreased control transmission power. Then, the UE keeps the data transmission power and increase the decreased control transmission power to an increased-decreased control transmission power in response to the second indication, when a second total transmission power of the data transmission power and the decreased control transmission power is smaller than the maximum transmission power.

In one example, the UE receives a third indication indicating the CQ degradation from the network. The UE decreases the data transmission power to a decreased data transmission power and increases the control transmission power to an increased control transmission power in response to the third indication, when the first total transmission power of the data transmission power and the control transmission power is greater than or equal to the maximum transmission power. In one example, the UE keeps the decreased data transmission power, when the decreased data transmission power is smaller than or equal to a data transmission power threshold.

In one example, the UE decreases the data transmission power and decreases the decreased control transmission power with a same proportion in response to receiving a fourth indication indicating the CQ improvement from the network, when the decreased control transmission power is smaller than or equal to a control transmission power threshold. In one example, the UE increases the data transmission power and increases the decreased control transmission power with a same proportion in response to receiving a fifth indication indicating the CQ degradation from the network, when the decreased control transmission power is smaller than or equal to the control transmission power threshold.

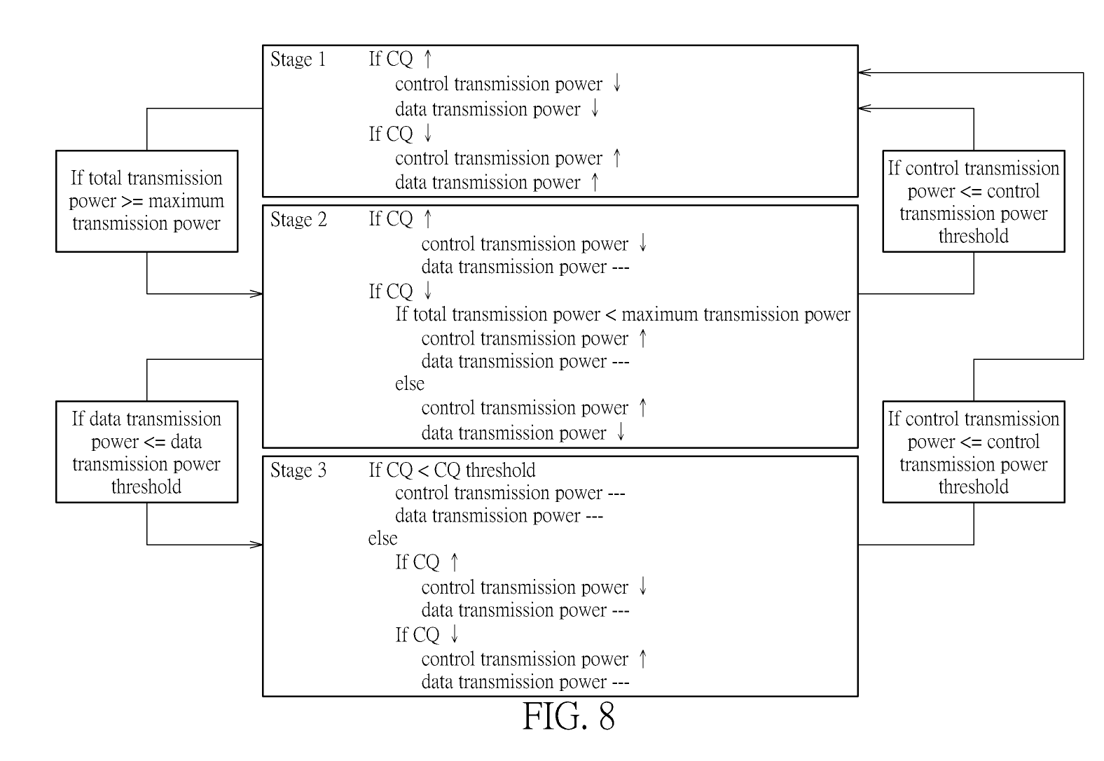

FIG. 8 is a schematic diagram of handling a power control according to an example of the present invention. In FIG. 8, the terms of “improve” and “increase” are represented by upward arrows, the terms of “degrade” and “decrease” are represented by downward arrows, and the term of “keep” is represented by a dotted line. In Stage 1, when a CQ improves, a control transmission power for transmitting a control channel and a data transmission power for transmitting a data channel are decreased. When the CQ degrades, the control transmission power and the data transmission power are increased. When the CQ keeps degrading and both the control transmission power and the data transmission power are kept being increased such that a total transmission power of the data transmission power and the control transmission power is greater than or equal to a maximum transmission power, the power control goes to Stage 2.

In Stage 2, when the CQ keeps degrading, the control transmission power is increased (e.g., to keep a certain level of a Signal to Interference plus Noise Ratio (SINR)). Because the total transmission power is already greater than or equal to the maximum transmission power, for increasing the control transmission power, the data transmission power should be decreased. On the other hand, when the CQ improves, the control transmission power is decreased and the data transmission power is kept (e.g., at a current level). Afterward, when the CQ degrades again, the control transmission power is increased. Because the total transmission power is not smaller than the maximum transmission power, the data transmission power is kept (e.g., at the current level). If the CQ keeps improving and the control transmission power keeps being decreased, the power control goes to Stage 1 when the decreased control transmission power is smaller than or equal to a control transmission power threshold. If the CQ keeps degrading, the control transmission power keeps being increased and the data transmission power keeps being decreased, the power control goes to Stage 3 when the decreased data transmission power is smaller than or equal to a data transmission power threshold.

In stage 3, the data transmission power is kept no matter the CQ is increased or decreased. When the CQ is smaller than a CQ threshold, the control transmission power is kept. When the CQ improves and is greater than or equal to the CQ threshold, the control transmission power is decreased when the CQ improves and the control transmission power is increased when the CQ degrades. When the CQ degrades again, the control transmission power is increased until the CQ is greater than the CQ threshold. If the CQ keeps improving and the control transmission power keeps being decreased, the power control goes to Stage 1 when the decreased control transmission power is smaller than or equal to the control transmission power threshold.

The following example may be applied to the FIGS. 3-8.

In one example, the data channel includes an Enhanced Dedicated Physical Data Channel (E-DPDCH), and the control channel includes a Dedicated Physical Control Channel (DPCCH). In one example, the network includes the CDMA network. “when” may be replaced by “if”.

Those skilled in the art should readily make combinations, modifications and/or alterations on the abovementioned steps, description and examples. Some steps described above may not be necessary for realizing the present invention. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the processes above may be compiled into the program codes 214.

To sum up, the present invention provides a method and related communication device for handling a power control. A UE keeps a data transmission power rather than preferentially adjusts the data transmission power, when a total transmission power of the data transmission power and a control power is greater than or equal to a maximum transmission power of the UE. Thus, the problem of handling the power control is solved.

The 3GPP standard (TS 25.214, v14.1.0, clause 5.1.2.6) discloses a method that: the UE preferentially reduces a data transmission power, when a total transmission power of the data transmission power and a control transmission power reaches a maximum transmission power. In other words, the UE reduces the data transmission power and does not reduce the control channel power, when the total transmission power reaches the maximum transmission power. The US patent (U.S. Pat. No. 7,330,446) discloses a method that: a transmission is suspended, when a transmission power reaches a maximum transmission power. Thus, the present invention provides a method different from the 3GPP standard and the US patent, to solve the problem of the power control.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a power control, comprising:
at least one storage device; and
at least one processing circuit, coupled to the at least one storage device, wherein the at least one storage device stores, and the at least one processing circuit is configured to execute instructions of:
receiving a first indication indicating the communication device to adjust a data transmission power or a control transmission power from a network;
keeping the data transmission power and keeping the control transmission power in response to the first indication, when a total transmission power of the data transmission power and the control transmission power is greater than or equal to a maximum transmission power; and
transmitting a data channel with the data transmission power and transmitting a control channel with the control transmission power.

2. The communication device of claim 1, wherein the instruction further comprises:
adjusting the data transmission power to an adjusted transmission power and adjusting the control transmission power to an adjusted control power with a same proportion in response to the first indication, when the total transmission power of the data transmission power and the control transmission power is smaller than the maximum transmission power; and
transmitting the data channel with the adjusted data transmission power and transmitting the control channel with the adjusted control transmission power.

3. The communication device of claim 1, wherein the instruction further comprises:
stopping keeping the data transmission power and stopping keeping the control transmission power, when receiving a second indication indicating the communication device to decrease the total transmission power from the network; and
decreasing the total transmission power in response to the second indication.

4. The communication device of claim 1, wherein the data channel comprises an Enhanced Dedicated Physical Data Channel (E-DPDCH), and the control channel comprises a Dedicated Physical Control Channel (DPCCH).

5. The communication device of claim 1, wherein the network comprises a Code Division Multiple Access (CDMA) network.

6. A communication device for handling a power control, comprising:
at least one storage device; and
at least one processing circuit, coupled to the at least one storage device, wherein the at least one storage device stores, and the at least one processing circuit is configured to execute instructions of:
receiving an indication indicating the communication device to adjust a data transmission power or a control transmission power from a network;
keeping the data transmission power and adjusting the control transmission power to an adjusted control transmission power in response to the indication, when a total transmission power of the data transmission power and the control transmission power is greater than a threshold and is smaller than a maximum transmission power; and
transmitting a data channel with the data transmission power and transmitting a control channel with the adjusted control transmission power.

7. The communication device of claim 6, wherein the instruction further comprises:
keeping the data transmission power and keeping the control transmission power in response to the indication, when the total transmission power of the data transmission power and the control transmission power is greater than or equal to the maximum transmission power; and
transmitting the data channel with the data transmission power and transmitting the control channel with the control transmission power.

8. The communication device of claim 6, wherein the instruction further comprises:
stopping keeping the data transmission power, when the total transmission power is smaller than the threshold.

9. The communication device of claim 6, wherein the instruction of adjusting the control transmission power to the adjusted control transmission power in response to the indication comprises:
decreasing the control transmission power to the adjusted control transmission power, when the indication indicates the communication device to decrease the control transmission power due to a CQ (CQ) improvement; and
increasing the control transmission power to the adjusted control transmission power, when the indication indicates the communication device to increase the control transmission power due to a CQ degradation.

10. The communication device of claim 6, wherein the data channel comprises an Enhanced Dedicated Physical Data Channel (E-DPDCH), and the control channel comprises a Dedicated Physical Control Channel (DPCCH).

11. The communication device of claim 6, wherein the network comprises a Code Division Multiple Access (CDMA) network.

12. A communication device for handling a power control, comprising:
at least one storage device; and
at least one processing circuit, coupled to the at least one storage device, wherein the at least one storage device stores, and the at least one processing circuit is configured to execute instructions of:
receiving a first indication indicating a CQ (CQ) improvement from the network;
keeping a data transmission power and decreasing a control transmission power to a decreased control transmission power in response to the first indication, when a first total transmission power of the data transmission power and the control transmission power is greater than or equal to a maximum transmission power; and
transmitting a data channel with the data transmission power and transmitting a control channel with the decreased control transmission power.

13. The communication device of claim 12, wherein the instruction further comprises:
receiving a second indication indicating a CQ degradation from the network, after keeping the data transmission power and decreasing the control transmission power to the decreased control transmission power; and
keeping the data transmission power and increasing the decreased control transmission power to an increased-decreased control transmission power in response to the second indication, when a second total transmission power of the data transmission power and the decreased control transmission power is smaller than the maximum transmission power.

14. The communication device of claim 12, wherein the instruction further comprises:
receiving a third indication indicating the CQ degradation from the network;
decreasing the data transmission power to a decreased data transmission power and increasing the control transmission power to an increased control transmission power in response to the third indication, when the first total transmission power of the data transmission power and the control transmission power is greater than or equal to the maximum transmission power.

15. The communication device of claim 14, wherein the instruction further comprises:
keeping the decreased data transmission power, when the decreased data transmission power is smaller than a data transmission power threshold.

16. The communication device of claim 12, wherein the instruction further comprises:
decreasing the data transmission power and decreasing the decreased control transmission power with a same proportion in response to receiving a fourth indication indicating the CQ improvement from the network, when the decreased control transmission power is smaller than a control transmission power threshold; and
increasing the data transmission power and increasing the decreased control transmission power with the same proportion in response to receiving a fifth indication indicating the CQ degradation from the network, when the decreased control transmission power is smaller than the control transmission power threshold.

17. The communication device of claim 12, wherein the data channel comprises an Enhanced Dedicated Physical Data Channel (E-DPDCH), and the control channel comprises a Dedicated Physical Control Channel (DPCCH).

18. The communication device of claim 12, wherein the network comprises a Code Division Multiple Access (CDMA) network.
